(19) United States
(12) Patent Application Publication
(10) Pub. No.: US 2012/0174829 A1
(43) Pub. Date: Jul. 12, 2012

(54) Light Mortar Materials and Method of Use

(75) Inventors: Shaoqiang LI, Shenzhen (CN); Qishan ZHANG, Shenzhen (CN); Xiaoyan GUO, Shenzhen (CN)

(73) Assignee: SHENZHEN GRANDLAND DECORATION GROUP CO., LTD., Shenzhen (CN)

(21) Appl. No.: 13/417,263

(22) Filed: Mar. 11, 2012

(30) Foreign Application Priority Data
Jun. 12, 2010 (CN) PCT/CN2010/079484
Aug. 7, 2010 (CN) 201010223052.7

(51) Int. Cl. C04B 14/24

(52) U.S. Cl. 106/676; 524/2

(57) ABSTRACT

A lightweight and energy saving mortar consisting of: 30-40% of Ordinary Portland cement; 2-4% of Hydrated lime; 10-20% of lightweight aggregate; 40-50% of heavyweight aggregate; and 1.0% of additive. The lightweight aggregate is a porous inorganic hollow glass material of fineness is smaller than 100 mesh. The heavyweight aggregate is Aeolian sand. During application, the mortar is diluted with water to have a viscosity suitable for mechanical spraying or manual application. The present invention employs a specific lightweight aggregate of porous inorganic hollow glass material to reduce the weight percentage of sand stone so as to decrease the weight of the mortar such that an elastic modulus of the mortar is matched with the lightweight wall object, the heat transmission coefficient is decreased, and the thermal bridge effect is minimized. Hollowing, cracking, and falling off problems are prevented. Heat and sound insulation are improved. Mechanical operation is facilitated.

### BACKGROUND OF THE PRESENT INVENTION

1. Field of Invention

The present invention relates to a type of mortar paste for construction use, and more particular to a mortar material which has a low density formula and its method of use.

2. Description of Related Arts

At present, it is common to use lightweight wall object such as aerated concrete block in construction projects with the regular existing mortar materials. The aerated concrete block has a mass ratio of about 600-800 kg/m3, a heat transmission coefficient of 0.14-0.20 W/(m·K25° C.); and the existing mortar materials is in general has the composition and mass ratio as follows: Ordinary Portland Cement (OPC) 20-30, hydrated lime 0-5, limestone sand 60-75. This type of mortar has a specific density of 1700-1800 kg/m3, which is not a lightweight mortar and does not match the lightweight wall object. In addition, this type of ordinary Portland cement has a modulus of elasticity which is significantly greater than that of the aerated concrete block. Because of the differences of elastic modulus, the plaster surface will experience greater force of deformation and crack in the plaster surface will be resulted. Also, the ordinary plaster has relatively higher heat transmission coefficient (which is 0.93 W/(m·K25° C.), which leads to ‘thermal bridge’ effect and causes contraction and deformation in such a manner that the plaster surface is hollowed and cracked. Moreover, the workability of the regular existing mortar materials is poor and many workers found great difficulties in mixing paste and polishing. Accordingly, the usual practice is to sprinkle cement powder onto the surface for surface polishing and therefore the plaster surface is subject to cracking and fails to protect or reinforce the wall structure or building structure. The cracking and falling of plaster materials impose safety hazard to the worker and the owner.

The regular existing mortar materials use limestone sand as the aggregate. For dry mortar, the aggregate has to be further processed in order to fulfill the application requirement in which the major processing steps involve screening and drying so as to remove unnecessary contents in the sand, adjust a grading of the sand and decrease the water content in the sand. During drying, introduction of hazardous materials into the sand has to be avoided and therefore the fuel used has to be clean for the drying process and the cost is relatively high. On the other hand, energy is consumed when the sand is processed for artificially fragmentation, while a lot of side products are produced which causes pollution to the environment.

During the process of mechanical application, owing to the fact that the regular existing mortar materials constitute a high proportion by weight, has a high material requirement and a great load in vertical transportation, are not energy-saving while easily causing problems to the mortar machine such as pump blockage, pipe blockage, mortar gun blockage which hinder a smooth operation of the mechanical processing and hence the efficiency is low. Also, the process requires frequent watering on the base surface and surface processing, and relies heavily on the skill of workers. Since the weight of the mortar is heavy and the strength of bonding is insufficient, the mortar is subject to falling and deformation, and hence multi-layered processing is required and the efficiency is low.

### SUMMARY OF THE PRESENT INVENTION

An object of the present invention is to provide a lightweight, energy efficient and environmental friendly mortar which utilizes Aeolian sand as the aggregate and is suitable for use with lightweight wall object while capable of preventing hollowing, cracking, falling off of the mortar as well as facilitating mechanical application in having features of high bonding strength.

Additional advantages and features of the invention will become apparent from the description which follows, and may be realized by means of the instrumentalities and combinations particular point out in the appended claims.

According to the present invention, the foregoing and other objects and advantages are attained by a lightweight, energy efficient and environmental friendly mortar, characterized in that, the mortar is a mixture which has a composition by weight as follows:

Ordinary Portland Cement (OPC) 30-40,

hydrated lime 2-4,

lightweight aggregate 10-20,

heavyweight aggregate 40-50,

compound additive 1.0;

wherein the lightweight aggregate is a type of porous inorganic hollow glass material which has a degree of fineness of less than 100 mesh;

wherein the heavyweight aggregate is Aeolian sand.

Preferably, the porous inorganic hollow glass material has a degree of fineness of 80-100 mesh.

The Aeolian sand is a mixture of a first Aeolian sand and a second Aeolian sand, wherein the first Aeolian sand has a degree of fineness of 50-70 mesh and the second Aeolian sand has a degree of fineness which is greater than 100 mesh, wherein the percentage by weight of the first and second Aeolian sand are 90% and 10% respectively.

The compound additive has a composition (by weight) as follows: 0.15 of methyl cellulose by weight, 0.2 of superabsorbent polymer by weight, 0.3 of air-entraining agent by weight, 0.35 of redispersable latex powder by weight.

The compound additive is c-type composite auxiliary which is sold by Guangzhou Hecheng Trading Co., Ltd.

Preferably, the lightweight and energy efficient mortar of the present invention is a mixture which has a composition by weight as follows:

Ordinary Portland Cement (OPC) 36,

hydrated lime 3,

lightweight aggregate 15,

heavyweight aggregate 45,

compound additive 1.0.

The hydrated lime has a degree of fineness of 300 mesh or above; the Ordinary Portland Cement has a degree of fineness of 185 mesh or above.

In addition, the present invention further provides a method of application comprising the steps of: diluting the lightweight mortar with water, wherein the water added is 30-50% by weight of the lightweight mortar; manually or mechanically stirring until mixing evenly such that a preset viscosity level is attained which is suitable for mechanical spraying or manual application. In other words, the lightweight mortar can be used for mechanical spraying or for manual application.

The present invention is based on the lightweight and environmental friendly concepts, which employs a specific lightweight aggregate of porous inorganic hollow glass material to reduce the weight percentage of sand stone so as to decrease the weight of the mortar materials, while matching the elastic modulus of the mortar and the lightweight wall object, decreasing the heat transmission coefficient, minimizing the thermal bridge effect, and therefore preventing hollowing, cracking, and falling off, and improving heat and sound insulation and facilitating mechanical operation or application. In addition, the Aeolian sand from the northwest desert (such as Ning Xia Zhong Wei desert) is used as the aggregate of which the sand has superior grading and distribution, highlighting the three-dimensional texture and providing a superior decorative effect. Also, the present invention utilizes a special additive, which is a composite additive having high level of workability, such that a superior application effect is achieved. Moreover, the problem of heavyweight related to vertical transportation is solved or mitigated.

The present invention utilizes Aeolian sand as the aggregate to formulate the mortar for use in wall objects. Since the fineness of the ordinary Portland cement is greater than 185 mesh, and the fineness of the hydrated lime is greater than 185 mesh, and the fineness of lightweight aggregate, which is porous inorganic hollow glass material, is smaller than 100 mesh (preferably 80-100 mesh), and the Aeolian sand belongs to texture granules (preferably, 90% of the Aeolian sand has a fineness of 50-70 mesh), therefore the distribution of the granular sand in the mortar resulted from this particle size arrangement leads to a superior mix such that the mortar layer as applied can demonstrate a protruding and indented pattern and texture similar to the appearance in nature. In addition, the mortar layer can be washed by water and polished to remove the concrete slurry on the surface and expose more layers of texture or surface, and is highly durable and environmental friendly. On the other hand, the particles mix is superior in that the filling effect is relatively complete and the mortar after drying has increased strength in stress resistance and tensile strength, that is to say, the stress and tensile force of deformation on the mortar layer are reduced and the damaging effect of hollowing, cracking and falling off on the mortar layer is effectively lessened. In addition, the Aeolian sand, which is used as the aggregate for the mortar of the present invention, has superior properties against wearing and external force when compared to regular existing mortar. In other words, an additional thick protection layer is provided to the wall through the mortar of the present invention.

Aeolian sand, which is used as the aggregate of the mortar of the present invention, has superior properties in aging resistance and fade resistance which provides a solid and durable color to the wall object, when compared to regular existing organic mortar. Even if the surface is scratched, the color provided through the aggregate of Aeolian sand is unchanged, and the color is not so obvious which is able to provide a simple and staple effect. The mortar layer is rich in expression and strong in texture which provides a natural, rich and strong European style and superior decorative effect or unique style to the surface of an architecture.

According to the present invention, the lightweight aggregate utilizes microporous inorganic hollow glass material, which is the major element to the lightweight feature. The addition of microporous inorganic hollow glass material increases gaps in the mortar and greatly reduces the overall weight of the mortar. The dry apparent density (kg/m3) of mortar is decreased from 1700-1800 to 700-1000, the decrease in weight can decrease the heat transmission coefficient W/(m·K25° C.) to reach a level of 0.15-0.25, which is equivalent to autoclaved aerated concrete block. In this way, the thermal bridge effect is avoided (the thermal bridge effect is resulted from the differences in heat transmission ability and uneven heat transmission, which lead to contraction deformation, condensation and mildew formation or even water drop, and then hollowing, cracking, and falling off of the mortar), and the contraction deformation is effective reduced. Also, heat insulation and temperature resistance is greatly increased.

According to the lightweight mortar of the present invention, the problem of cracking is mitigated which ensures the quality of the construction project is maintained: 1) common existing wall objects are aerated concreted which belongs to lightweight wall objects, the elastic modulus of the lightweight wall object and the lightweight mortar are fitted to use together (Elastic modulus refers to a tendency to deform elastically caused by the deformation force resulted from the changes in humidity, surrounding temperature, and water content of hydrated products and carbonized products produced in the drying substances during a drying process of the surface mortar, wherein when the value is higher, the deformation force is higher. That is to say, under the effect of a unit force, the elastic deformation is lower when the lightweight mortar of the present invention is used), such that the elastic modulus of the mortar is increased to a value which is close to the elastic modulus of the base structure (such as the wall object) such that the elastic modulus of the mortar and the base structure are similar in level and the force required to cause elastic deformation are approximately the same; 2) microporous inorganic hollow glass material provides micro pores which is capable of blocking micro-cracking development in the mortar after drying, therefore decreasing the stress concentration factor of the gaps in the mortar and increasing the resistance to tensile and shearing forces; 3) the additive further provides a composite additive which contains methyl cellulose which has a strong cross-linking effect such that the composition which includes the cement, the lightweight aggregate and the heavyweight aggregate can be mixed to form a three-dimensional structure in which the cellulose provides a long-chain structure and interlinking ability to the surface and hence the compositions can be bonded effectively. In addition, the cellulose cell dimension is stable and therefore the different elements in the compositions are well-linked and will not easily contracted and settled, therefore the possibility of hollowing and cracking is reduced; 4) the composite additive further includes a redispersable latex powder which contributes a preset level of flexibility to the mortar such that the strength of tensile force resistance and the elasticity and contraction resistance are further increased. In other words, the architecture is just like wearing an elastic jacket and has achieved a special level of toughness.

The lightweight mortar of the present invention is capable of increasing the workability related to operation or application of the mortar, therefore is advantageous to use in mechanical application in which pumping and spraying are required. Accordingly, the efficiency and quality of the application is increased dramatically. 1) the addition of microporous inorganic hollow glass material can lighten the mortar, making movements of the sand particles between particles of different sizes in the composition relatively easy and smoothen the texture of the composition, that is, the workability and the spraying ability are increased; 2) the composite additive, which is the c-type composite additive, contains methyl cellulose which has a strong linkage ability and is capable of retaining water therein such that the mortar has improved water retaining ability and is easier to manipulate when applying on a work surface; 3) the redispersable latex powder can also improve the fluidity of the mortar. 4) the superior mix of the composition in view of particle size and the lightweight construction can allow the mortar of the present invention to be used in mechanical application. Since the particle size distribution curve and the pumpability have a direct proportional relationship, when the particle size distribution is increased, the pumpability is increased. In other words, the lightweight feature in mortar construction of the mortar of the present invention solves the problems of pump blockage, pipe blockage or gun blockage of the regular existing mortar.

The use of microporous inorganic hollow glass material can increase the porosity of the lightweight mortar of the present invention, decrease the material usage per unit area, and dramatically decrease the weight requirement for vertical transportation through the lightweight feature, therefore energy efficient is achieved and the cost of manufacture per unit area is reduced effectively.

The lightweight mortar of the present invention is complementary to the lightweight wall object so that the problems of hollowing, cracking and falling off are solved. The property of crack resistance is good and the bond strength is sufficient, therefore the hardened layer of mortar can be used in the absence of any additional mesh support and without any problems of hollowing and falling off. The mortar is very suitable for use in protruding and indented corners, easy to leveling, and suitable to facilitate modular and mechanical application. The step of application is simple and practical while the cost of manufacture per unit square meter is low. Through reducing the vertical transportation weight requirement, the heat insulation and sound insulation is improved, thereby achieving an energy efficient effect. The mortar makes use of Aeolian sand which is a source derived from an environmental friendly manufacture method, therefore capable of exploring and making use of remote desert natural resources in urban area for providing construction materials on a large scale, and therefore assisting development in areas surrounding the desert which may promote desert wind management, afforestation and restoration of natural environment, carbon dioxide capture and carbon capture. These are all very important issues and the exploration of use of Aeolian sand in construction is a very meaningful project which is novel and bold exploration and attempt.

Still further objects and advantages will become apparent from a consideration of the ensuing description and drawings.

These and other objectives, features, and advantages of the present invention will become apparent from the following detailed description, the accompanying drawings, and the appended claims.

### DETAILED DESCRIPTION OF THE PREFERRED EMBODIMENT

According to the present invention, a composition of lightweight and energy saving mortar having a mixture composition by weight present invention is provided. The mixture composition can make use of substances and products in the market. Five exemplary embodiments with different mixture compositions and their weights are illustrated in Table 1.

TABLE 1
(Unite: kilogram)

| Item | Name of raw | Manufacture | Exemplary Embodiment | | | | |
|---|---|---|---|---|---|---|---|
| no. | materials | or model | 1 | 2 | 3 | 4 | 5 |
| 1 | Ordinary | general | 30 | 32 | 36 | 37 | 40 |
| | Portland cement | | | | | | |
| 2 | Hydrated lime | general | 4 | 3 | 3 | 2 | 2 |
| 3 | lightweight | Huayu | 15 | 16 | 15 | 20 | 10 |
| | aggregate | Mining | | | | | |
| 4 | heavyweight | NingXia | 50 | 48 | 45 | 40 | 47 |
| | aggregate | Zhongwei | | | | | |
| 5 | composite | Guangzhou | 1 | 1 | 1 | 1 | 1 |
| | additive | Hecheng | | | | | |

The ordinary Portland cement has a fineness greater than 185 mesh and the hydrated lime has a fineness greater than 300 from general manufactures in the market; preferably, the lightweight aggregate is a microporous inorganic hollow glass material which has a fineness of 80-100 mesh (a fineness smaller than 100 mesh can be used in the present invention); the heavyweight aggregate utilizes Aeolian sand from Ning Xia Zhong Wei desert, wherein the Aeolian sand is formed after natural wind transportation, grading and settlement onto the ground, its particle size is evenly distributed, small, and its composition is stable, wherein in the Aeolian sand, 90% of the Aeolian sand has a fineness of 50-70 mesh and the rest has a fineness greater than 100 mesh.

The composite additive is a C-type composite additive obtained from Guangzhou Hecheng Trading Co., Ltd. In each of the following exemplary embodiments, each kg of composite additive includes 0.15 kg methyl cellulose, 0.2 kg superabsorbent agent, 0.3 kg air-entraining agent and 0.35 kg redispersable latex powder. The C-type composite additive is obtained in the existing market and can be obtained from general manufacturers.

The present invention is further described in details as follows:

### Embodiment 1

The mixture composition is obtained according to the composition as shown in Table 1, and then is processed as follows: mixing ordinary Portland cement, hydrated lime, lightweight aggregate, heavyweight aggregate (Aeolian sand) and C-type composite additive; stirring evenly through mechanical mixing device to obtain the product of lightweight and energy saving mortar of embodiment 1 of the present invention; then packing by paper bag or placing in a container.

Application method (Method of Use): Obtain 100 kg of lightweight and energy saving mortar of embodiment 1 of the present invention; add 30 kg water to dilute the mortar; and mixing evenly by mechanical or manual method such that the diluted mortar has a viscosity which is suitable for mechanical application (such as spraying) or manual application (such as coating). Then, the diluted mortar can be used for application, by mechanical tools or by hands.

According to the national standard in China or in the field, standard tests are performed and the results are shown in the data for embodiment 1 in Table 2. The testing basis of hardened surface density, heat transmission coefficient and tensile strength resistant are GB/T20473-2006, and the basis of bonding strength (28d) is SJG11-2004.

### Embodiment 2

The mixture composition is obtained according to the composition for embodiment 2 in Table 1, and is then processed with the same method as described in embodiment 1 to obtain the product of lightweight and energy saving mortar of embodiment 2 of the present invention; repeat the application method described in embodiment 1, add 35 kg water to dilute the mortar; and mixing evenly by mechanical or manual method; and then apply the diluted mortar by mechanical tools or by hands. Standard performance testing is conducted as in embodiment 1 and the results are shown in the data for embodiment 2 in Table 2.

### Embodiment 3

The mixture composition is obtained according to the composition for embodiment 3 in Table 1, and is then processed with the same method as described in embodiment 1 to obtain the product of lightweight and energy saving mortar of embodiment 3 of the present invention; repeat the application method described in embodiment 1, obtain 100 kg mortar and add 40 kg water to dilute the mortar; and mixing evenly by mechanical or manual method; and then apply the diluted mortar by mechanical tools or by hands. Standard performance testing is conducted as in embodiment 1 and the results are shown in the data for embodiment 3 in Table 2.

### Embodiment 4

The mixture composition is obtained according to the composition for embodiment 4 in Table 1, and is then processed with the same method as described in embodiment 1 to obtain the product of lightweight and energy saving mortar of embodiment 4 of the present invention; repeat the application method described in embodiment 1, obtain 100 kg mortar and add 45 kg water to dilute the mortar; and mixing evenly by mechanical or manual method; and then apply the diluted mortar by mechanical tools or by hands. Standard performance testing is conducted as in embodiment 1 and the results are shown in the data for embodiment 4 in Table 2.

### Embodiment 5

The mixture composition is obtained according to the composition for embodiment 5 in Table 1, and is then processed with the same method as described in embodiment 1 to obtain the product of lightweight and energy saving mortar of embodiment 5 of the present invention; repeat the application method described in embodiment 1, obtain 100 kg mortar and add 50 kg water to dilute the mortar; and mixing evenly by mechanical or manual method; and then apply the diluted mortar by mechanical tools or by hands. Standard performance testing is conducted as in embodiment 1 and the results are shown in the data for embodiment 5 in Table 2.

TABLE 2

| Item | | Exemplary Embodiment | | | | |
|---|---|---|---|---|---|---|
| no. | Description | 1 | 2 | 3 | 4 | 5 |
| 1 | hardened surface | 938 | 843 | 781 | 709 | 986 |
| | density, kg/m³ | | | | | |
| 2 | heat transmission | 0.23 | 0.19 | 0.18 | 0.16 | 0.25 |
| | coefficient, | | | | | |
| | W/(m · K) | | | | | |
| 3 | Bond strength | 0.36 | 0.39 | 0.41 | 0.44 | 0.48 |
| | (28th day), MPa | | | | | |
| 4 | Compression | 2.0 | 2.03 | 2.07 | 1.70 | 2.64 |
| | Strength, MPa | | | | | |

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A composition of lightweight and energy saving mortar having a mixture composition by weight, consisting of:
30-40% of Ordinary Portland cement;
2-4% of Hydrated lime;
10-20% of lightweight aggregate;
40-50% of heavyweight aggregate; and
1.0% of additive,
wherein said lightweight aggregate is a porous inorganic hollow glass material of which a degree of fineness is smaller than 100 mesh,
wherein said heavyweight aggregate is Aeolian sand.

2. The composition of lightweight and energy saving mortar, as recited in claim 1, wherein said degree of fineness of said porous inorganic hollow glass material of said lightweight aggregate is 80-100 mesh.

3. The composition of lightweight and energy saving mortar, as recited in claim 1, wherein said Aeolian sand consists of a first Aeolian sand constituent and a second Aeolian sand constituent, wherein said first Aeolian sand constituent has a degree of fineness which is 50-70 mesh and a percentage weight of greater than 90% of said Aeolian sand, wherein said second Aeolian sand has a degree of fineness which is greater than 100 mesh.

4. The composition of lightweight and energy saving mortar, as recited in claim 1, wherein said additive is a composite additive consisting of methyl cellulose, superabsorbent agent, air-entraining agent and redispersable latex powder, wherein a percentage weight of said methyl cellulose, superabsorbent agent, air-entraining agent and redispersable latex powder in said composite additive are 0.15, 0.2, 0.3 and 0.35 respectively.

5. The composition of lightweight and energy saving mortar, as recited in claim 4, wherein said additive is a composite additive having a formula identical to a type-C composite additive which is sold by Guangzhou Hecheng Trading Co., Limited.

6. The composition of lightweight and energy saving mortar, as recited in claim 4, wherein said mixture composition by weight of said mortar consists of:
36% of Ordinary Portland cement;
3% of Hydrated lime;
15% of lightweight aggregate;
45% of heavyweight aggregate; and
1.0% of additive.

7. The composition of lightweight and energy saving mortar, as recited in claim 1, wherein said hydrated lime has a degree of fineness greater than 300 mesh and said Ordinary Portland cement has a degree of fineness greater than 185 mesh.

8. The composition of lightweight and energy saving mortar, as recited in claim 1, wherein said mortar is capable of being used for mechanical spraying or manual application through an application process comprising the step of: providing said mortar; diluting said mortar with water of which the water is 30-50% by weight of said mortar; stirring said mortar and the water until said mortar and the water are evenly mixed to form a mortar mixture which has a viscosity applicable for mechanical spraying or manual application.

9. The composition of lightweight and energy saving mortar, as recited in claim 2, wherein said additive is a composite additive consisting of methyl cellulose, superabsorbent agent, air-entraining agent and redispersable latex powder, wherein a percentage weight of said methyl cellulose, superabsorbent agent, air-entraining agent and redispersable latex powder in said composite additive are 0.15, 0.2, 0.3 and 0.35 respectively.

10. The composition of lightweight and energy saving mortar, as recited in claim 9, wherein said additive is a composite additive having a formula identical to a type-C composite additive which is sold by Guangzhou Hecheng Trading Co., Limited.

11. The composition of lightweight and energy saving mortar, as recited in claim 9, wherein said mixture composition by weight of said mortar consists of:
36% of Ordinary Portland cement;
3% of Hydrated lime;
15% of lightweight aggregate;
45% of heavyweight aggregate; and
1.0% of additive.

12. The composition of lightweight and energy saving mortar, as recited in claim 3, wherein said additive is a composite additive consisting of methyl cellulose, superabsorbent agent, air-entraining agent and redispersable latex powder, wherein a percentage weight of said methyl cellulose, superabsorbent agent, air-entraining agent and redispersable latex powder in said composite additive are 0.15, 0.2, 0.3 and 0.35 respectively.

13. The composition of lightweight and energy saving mortar, as recited in claim 12, wherein said additive is a composite additive having a formula identical to a type-C composite additive which is sold by Guangzhou Hecheng Trading Co., Limited.

14. The composition of lightweight and energy saving mortar, as recited in claim 12, wherein said mixture composition by weight of said mortar consists of:
36% of Ordinary Portland cement;
3% of Hydrated lime;
15% of lightweight aggregate;
45% of heavyweight aggregate; and
1.0% of additive.

15. The composition of lightweight and energy saving mortar, as recited in claim 2, wherein said mortar is capable of being used for mechanical spraying or manual application through an application process comprising the step of: providing said mortar; diluting said mortar with water of which the water is 30-50% by weight of said mortar; stirring said mortar and the water until said mortar and the water are evenly mixed to form a mortar mixture which has a viscosity applicable for mechanical spraying or manual application.

16. The composition of lightweight and energy saving mortar, as recited in claim 3, wherein said mortar is capable of being used for mechanical spraying or manual application through an application process comprising the step of: providing said mortar; diluting said mortar with water of which the water is 30-50% by weight of said mortar; stirring said mortar and the water until said mortar and the water are evenly mixed to form a mortar mixture which has a viscosity applicable for mechanical spraying or manual application.

17. The composition of lightweight and energy saving mortar, as recited in claim 4, wherein said mortar is capable of being used for mechanical spraying or manual application through an application process comprising the step of: providing said mortar; diluting said mortar with water of which the water is 30-50% by weight of said mortar; stirring said mortar and the water until said mortar and the water are evenly mixed to form a mortar mixture which has a viscosity applicable for mechanical spraying or manual application.

18. The composition of lightweight and energy saving mortar, as recited in claim 6, wherein said mortar is capable of being used for mechanical spraying or manual application through an application process comprising the step of: providing said mortar; diluting said mortar with water of which the water is 30-50% by weight of said mortar; stirring said mortar and the water until said mortar and the water are evenly mixed to form a mortar mixture which has a viscosity applicable for mechanical spraying or manual application.

19. The composition of lightweight and energy saving mortar, as recited in claim 11, wherein said mortar is capable of being used for mechanical spraying or manual application through an application process comprising the step of: providing said mortar; diluting said mortar with water of which the water is 30-50% by weight of said mortar; stirring said mortar and the water until said mortar and the water are evenly mixed to form a mortar mixture which has a viscosity applicable for mechanical spraying or manual application.

20. The composition of lightweight and energy saving mortar, as recited in claim 14, wherein said mortar is capable of being used for mechanical spraying or manual application through an application process comprising the step of: providing said mortar; diluting said mortar with water of which the water is 30-50% by weight of said mortar; stirring said mortar and the water until said mortar and the water are evenly mixed to form a mortar mixture which has a viscosity applicable for mechanical spraying or manual application.
